(19) United States
(12) Patent Application Publication
(10) Pub. No.: US 2009/0232184 A1
(43) Pub. Date: Sep. 17, 2009

(54) DIGITAL FOOD THERMOMETER WITH FAST RESPONSE PROBE

(76) Inventor: Richard Rund, Great Falls, VA (US)

Correspondence Address: General Counsel, P.C., 6862 Elm Street, SUITE 800, McLean, VA, 22101, US

(21) Appl. No.: 12/471,219

(22) Filed: May 22, 2009

Related U.S. Application Data
(63) Continuation of application No. 11/344,531, filed on Feb. 1, 2006.
Application No. 11/344,531 is a continuation-in-part of application No. 11/239,636, filed on Sep. 30, 2005, now abandoned.
Application No. 11/239,636 is a continuation of application No. PCT/US2004/010178, filed on Apr. 2, 2004.
(60) Provisional application No. 60/648,409, filed on Feb. 1, 2005.
(60) Provisional application No. 60/459,256, filed on Apr. 2, 2003.

(51) Int. Cl. G01K 7/22; G01K 1/00

(52) U.S. Cl. 374/170; 374/208; 374/E07.028

(57) ABSTRACT

A digital thermometer having a fast response probe is provided. The probe preferably has a distal end and a proximal end, the proximal end including an opening; a temperature sensing element disposed in said probe housing proximate to the opening and a thermally conductive food safe coating covering the opening. The probe is connected to a housing including thermometer circuitry and, preferably, a temperature display. The thermometer generates a reading to an accuracy of within +/−0.5° F. in a temperature range of between 130° F. to 150° F. The thermometer reaches a stabilized reading within 8 seconds or less.

### CROSS REFERENCE TO RELATED APPLICATIONS

This application is a continuation of U.S. patent application Ser. No. 11/344,531 filed Oct. 5, 2006, which is in turn a continuation-in-part of U.S. patent application Ser. No. 11/239,636 filed Sep. 30, 2005, which in turn is a continuation of PCT/US2004/010178 filed Apr. 2, 2004 which claims the benefit of U.S. Patent Application Ser. No. 60/459,256 filed Apr. 2, 2003. This application claims the benefit of U.S. Provisional Patent Application Ser. No. 60/648,409 filed Feb. 1, 2005, which is incorporated by reference herein in its entirety.

### FIELD OF THE INVENTION

This invention relates generally to temperature probes and, more particularly, to a temperature probe for use in with digital food thermometers.

### BACKGROUND

Accurate, reliable and instantaneous sensing and measuring of temperature of food items is critically important. The most accurate and expedient manner in which to measure the temperature of a food item is by inserting a temperature-sensing device into the food item. A commonly used device is a digital thermometer.

It is very important to thoroughly clean the thermometer probe after each use. If food particles become lodged in the probe, food borne bacteria may develop. If the probe is not cleaned prior to its next use, those food borne bacteria could be transmitted to the food item.

Conventional digital thermometers include probes that are designed for insertion into food items. These probes are frequently fabricated from a metal such as stainless steel. An exemplary probe is disclosed in U.S. Pat. No. 3,975,720. There, probe 38 having a thermistor 42 disposed therein near distal end 4 is illustrated in FIG. 1. This style probe is satisfactory for some applications, but it tends to have a response time that is undesirably slow for many applications due to the separation between the thermistor and the food item.

There are known probe designs that exhibit increased response times. Exemplary probes are described in U.S. Pat. Nos. 4,133,208 and 6,000,845. The probe of the '208 patent is illustrated in FIG. 2. The probe includes a shank 24b having an open distal end. A semi-conductor temperature sensing element 41b is disposed in and protrudes through the open distal end. The ends 51 of shank 24b are swedged around semi-conductor temperature sensing element 41b and the interior of shank 24b is filled with epoxy 49b. The probe of the '845 patent is shown in FIG. 3. That probe is constructed from stainless steel and has a sensing end 28 that is inwardly tapered and has an opening 281. The probe encloses a temperature sensor 32. A temperature sensing point 324 of temperature sensor 32 protrudes partially from opening 281.

The response times of the probe of the '208 patent and the probe of the '845 patent are more rapid than those of the traditional closed end probes because, as used, the temperature sensing element makes direct contact with the food item. However, in making direct contact, food is likely to become lodged or wedged in the crevices between end portions of the probe and the temperature-sensing element making it difficult to clean the probe. Food build-up can be dangerous as it can be a haven for food borne bacteria. In addition, it is believed to be unhealthy to directly contact the food item with the temperature-sensing element.

Accordingly, there remains a need for a probe for a digital thermometer that is both food safe and has a rapid response time.

### SUMMARY

It is an object of this invention to provide a thermometer probe that has a rapid response time.

It is a further object of the invention to provide a thermometer probe that is easy to clean.

It is still another object of the invention to provide a thermometer probe that minimizes transmission of food borne bacteria.

In accordance with an aspect of the invention, a thermometer probe includes a probe housing having a distal end and a proximal end and the proximal end includes an opening or cavity an opening. A temperature sensing element, preferably a thermistor, is disposed in the probe housing close to the cavity. The cavity is covered by a thermally conductive, food safe coating.

Given the following enabling description of the drawings, the apparatus should become evident to a person of ordinary skill in the art.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 illustrates a prior art food thermometer.

FIG. 2 depicts another prior art probe.

FIG. 3 shows still another prior art probes.

FIG. 4 illustrates a cross-sectional view of an embodiment of a probe in accordance with the invention.

FIG. 5 depicts another embodiment of the probe of the present invention.

FIG. 6 is a response time comparison between a prior art probe and the probe of the invention.

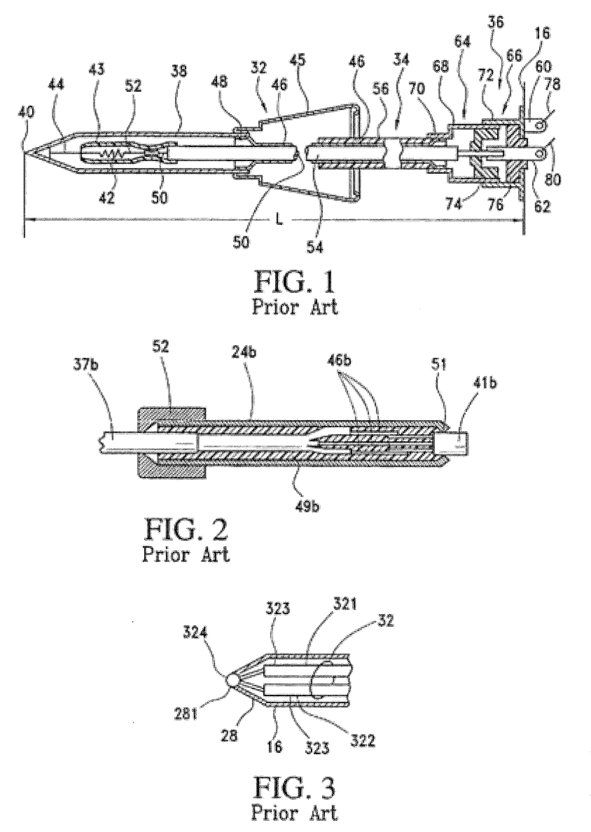

### DETAILED DESCRIPTION

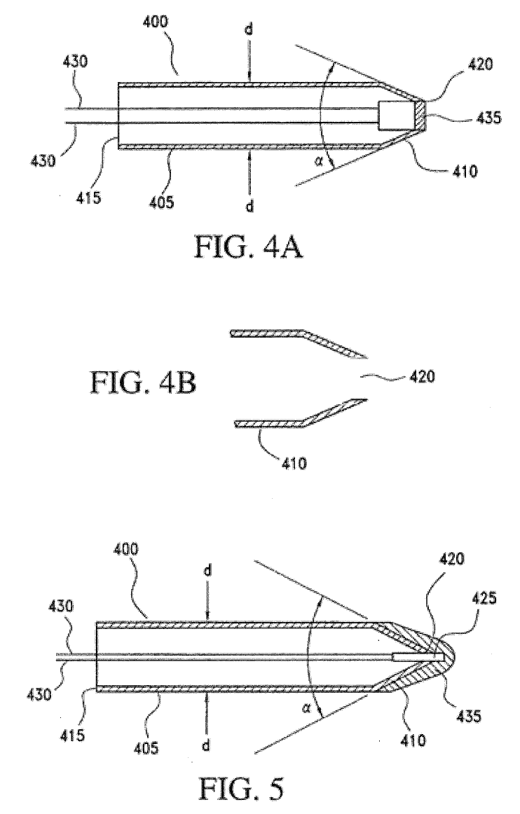

FIG. 4a shows a cross-sectional view of a probe 460 according to an embodiment of the invention. The probe 400 includes a probe housing 405 having a proximal end 410 and a distal end 415. As best shown in FIG. 4b, proximal end 410 includes an opening 420. A temperature-sensing device 425 is preferably disposed within housing 405 proximate to an opening or cavity 420. Temperature sensing device 425 includes a proximal surface and a distal surface. In addition, temperature sensor 425 may include lead wires 430, or other coupling mechanisms, that extend through probe housing 405 to couple temperature sensing device 425 to thermometer circuitry (not shown) for displaying the measured temperature. A preferred temperature-sensing device is a GT thermistor such as the 104GT thermistor available from Ishizuka Electronics Corporation (Semitec) of Tokyo, Japan.

In accordance with an aspect of the invention, a thermally conductive food safe coating is applied over opening 420 to promote heat transfer from the food item and to minimize the potential of unwanted food build-up in proximal end 410. As illustrated in FIG. 4a, the opening 420 is preferably filled with coating 435. However, in some embodiments the coating may not fill the entire opening and there may be a small gap between the proximal surface of temperature sensing device 425 and coating. Alternatively, as illustrated in FIG. 5, temperature-sensing device 425 may be disposed such that it protrudes through opening 420. In this embodiment, coating 435 may cover the entire exposed surface of temperature sensing device 425 as well as the seam between temperature sensing device 425 and probe housing 405, or the entire exposed surface of temperature sensing device 425 and some or all of proximal end 410. Preferred coatings include TEFLON®, particularly polytetrafluoroethylene and fluorinated ethylene propylene copolymer, and thermoset powder coatings such as ER05-3D9 available from Pioneer Powder Products of Melrose, Park Ill.

In accordance with another aspect of the invention, proximal end 410 is preferably tapered as depicted in FIGS. 4 and 5. However, proximal end 410 may be, flat, rounded or otherwise configured to suit the user's application.

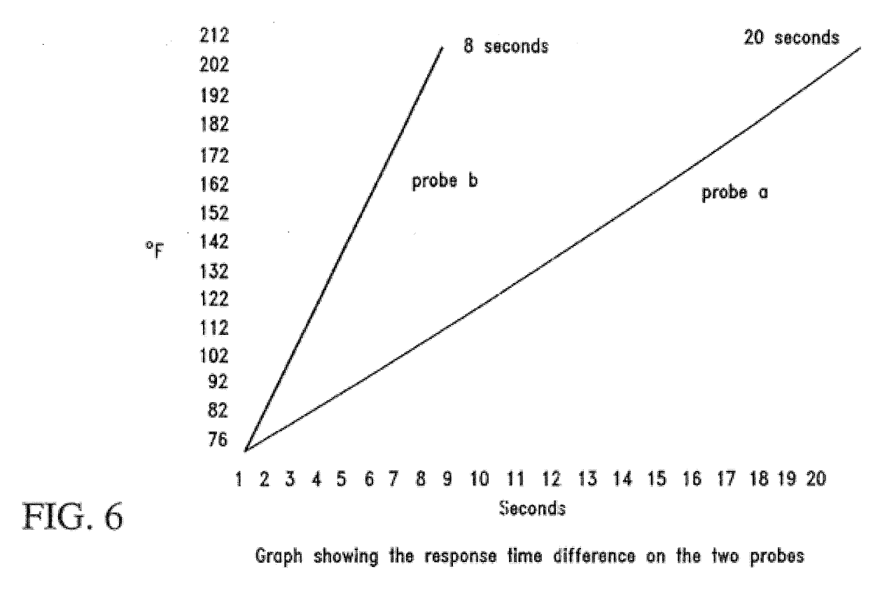

FIG. 6 illustrates a graph comparing response time of a conventional digital thermometer having a closed end probe to that of a digital thermometer having a probe according to the present invention. The response time was measured from room temperature, approximately 76° F., or 24° C., to the boiling point of water, 212° F., or 100° C. The conventional closed end probe of FIG. 6 (probe a) is comprised of SUS 304 stainless steel housing that is about 80 mm long with a diameter d of about 3.4 mm. Probe a includes a tapered proximal end having a taper angle α of about 26°. A Semitec 104GT thermistor is disposed in probe a proximate to the proximal end. Probe b of FIG. 6 is similar to probe a but further includes an opening having an inner radius of about 4 mm and an outer radius of about 5 mm. The thermistor is placed in the proximal end as close to the opening as possible. The opening was coated with TEFLON®. The response time for probe a was 20 seconds and the response time for probe b was 8 seconds. Accordingly, probe b has a response time that is reduced by about 60% from the response time of probe a.

In keeping with the invention, the probe may be connected to a housing containing thermometer circuitry. The housing may also contain, for example, a temperature display, and a variety of user actuated controls. Thermometer circuitry preferably includes microprocessor that receives input signals from the temperature-sensing device 425 and converts those signals to a temperature reading for display. In accordance with a preferred aspect of the invention, the microprocessor is appropriately programmed to provide a stabilized (+/−0.3° F.) reading in 8 seconds or less measured from room temperature to boiling water. The microprocessor may also be programmed to provide enhanced accuracy in the important food safety temperature range. For example, the microprocessor of the present embodiment is programmed to be accurate within +/−0.5° F. in the temperature range of 130° F. to 180° F.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A digital food thermometer for rapid measurement of consumables, said thermometer comprising:
a probe body having a distal end and a proximal end, the proximal end including an opening;
a temperature sensor, disposed in said probe, protruding through said opening;
an inert, polymer barrier, surrounding portions of said sensor protruding through said opening, in contact with said sensor and substantially unreactive to a wide variety of consumables, wherein said temperature includes a contact surface dimensioned to contact the consumables;
a housing, in electrical communication with said probe, with a digital temperature display; and
a thermometer circuit, connected to said sensor, with a processor that coacts with said display to provide a stabilized temperature reading in less than eight seconds,
wherein said polymer barrier includes a composition and thickness from said contact surface to said sensor that is dimensioned to permit total thermal transmission from the consumable through said barrier to said sensor in less than eight seconds.

2. The thermometer of claim 1 wherein said probe body includes a tapered proximal end with a barrier that covers said tapered portion of said proximal end.

3. The thermometer of claim 1 wherein said barrier is contiguous to surrounding portions of said sensor protruding through said opening.

4. The thermometer of claim 1 further comprising means for providing a reading that is accurate to within +/−0.5° F. in a temperature range of between about 130° F. and about 150° F.

5. The thermometer of claim 1 wherein said sensor includes a thermistor.

6. The thermometer of claim 1 wherein said barrier includes a polymer layer uniform in composition.

7. The thermometer of claim 6 wherein said probe body includes a substantially uniform probe body lacking substantial crevices amenable to solid consumable portion retention.

8. The thermometer of claim 1 wherein said probe is affixed to said housing.

9. A digital food thermometer for rapid measurement of consumables, said thermometer comprising:
a probe body having a distal end and a proximal end, the proximal end including an opening;
a temperature sensor, disposed in said probe, spatially adjacent to said opening;
a uniform, inert polymer layer substantially unreactive to consumables, covering said opening, and in contact with said sensor;
a housing, in electrical communication with said probe, with a digital temperature display; and
a thermometer circuit, connected to said sensor, with a processor that coacts with said display to provide a stabilized temperature reading in less than eight seconds,
wherein said polymer barrier includes a composition and thickness from said contact surface to said sensor that is dimensioned to permit total thermal transmission from the consumable through said barrier to said sensor in less than eight seconds.

10. The thermometer of claim 9 wherein said sensor protrudes from said opening.

11. The thermometer of claim 10 wherein said probe body includes a tapered proximal end with a barrier that covers said tapered portion of said proximal end.

12. The thermometer of claim 11 wherein proximal end includes a barrier that covers said tapered portion of said proximal end.

13. The thermometer of claim 12 wherein said barrier is contiguous to surrounding portions of said sensor protruding through said opening.

14. A digital food thermometer for rapid measurement of consumables, said thermometer comprising:
a substantially uniform probe body lacking substantial crevices amenable to solid consumable portion retention, and with a proximal end having an opening;
a temperature sensor, disposed in said probe, spatially adjacent to said opening;
a uniform, inert polymer layer substantially unreactive to consumables, covering said opening in a substantially flush manner with said probe body, and in contact with said sensor;
a housing, coupled to said probe, with a digital temperature display; and
a thermometer circuit, connected to said sensor, with a processor that coacts with said display to provide a stabilized temperature reading in less than eight seconds.
